(19) United States
(12) Patent Application Publication
(10) Pub. No.: US 2016/0144358 A1
(43) Pub. Date: May 26, 2016

(54) Dynamic Lab on a Chip Based Point-Of-Care Device For Analysis of Pluripotent Stem Cells, Tumor Cells, Drug Metabolites, Immunological Response, Glucose Monitoring, Hospital Based Infectious Diseases, and Drone Delivery Point-of-Care Systems

(71) Applicant: Nilesh Patel, Oakland, CA (US)

(72) Inventor: Nilesh Patel, Oakland, CA (US)

(21) Appl. No.: 15/009,793

(22) Filed: Jan. 28, 2016

(51) Int. Cl. B01L 3/00; G06F 19/00; G06F 19/18; G01N 27/447

(52) U.S. Cl. CPC B01L 3/5027; G01N 27/44791; G06F 19/3412; G06F 19/18; B01L 2200/10; B01L 2300/023; B01L 2300/0636

(57) ABSTRACT

The invention provides for a novel dynamically configurable point-of-care device for clinical diagnostics and research for analysis of activity associated with pluripotent stem cells, tumor cells, drug metabolites, immunological response, glucose monitoring, cardiovascular diseases, liver cell therapy, cell-cell signaling, epidemic outbreaks, hospital based infectious diseases, pathogens, germ cells, pharmacological compounds, oxidation reduction, microscopy, tomography, flow cytometry, clinical lab testing, and for providing immunoassays, ELISA, electrophoresis, PCR, chromatography, and other laboratory functions. The device comprises a biochemical processing module further comprising a processor and at least one controller, receiving microfluidic elements, sensors, software scripts, an electrically operated interface, flow ports, a user interface, memory, and a communications link, configurable based on analysis of patient data. The invention further provides for multiple-criteria decision analysis for hospital administrators, a wearable device, mobile medical device, molecular electronics configuration, touchscreen recognition, data analytics application, and a drone delivery based point-of-care system.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

The present invention relates to lab-on-a-chip devices with embedded structural reconfiguration capabilities with an integrated computer interface that is used for point-of-care clinical diagnostics and research.

### GENERAL BACKGROUND AND STATE OF THE ART

Healthcare organizations and professionals have a need for robust point-of-care testing for an increasingly complex and growing patient population. The present invention provides a novel point-of-care diagnostic tool for clinical and research purposes, utilizing well known methods and techniques from microfluidics, and mechanical, chemical, biological, electrical, and computer engineering.

Lab-on-a-chip (LOC) devices based on microfluidics, incorporating microelectromechanical systems (MEMS), have become an important part of laboratory and clinical applications, including for patient testing and care as well as research.

While many static lab-on-a-chip systems exists, they lack the ability to provide a low-cost solution to the wide variety of testing and research needs that exists in healthcare. For example, static systems require that a LOC device be built for a specific type of chemical process, such as testing for the presence of certain biomolecules. This is limiting and costly for researchers and health care organizations especially for those attempting to leverage LOC technology in clinical medicine. The present invention is directed to a low cost solution to address this need by providing a dynamic, or reconfigurable, LOC based analysis device where electrically powered hardware can be reconfigured or changed based on execution of a software algorithm operatively linked to the hardware.

There is a lack of solutions that can effectively utilize clinical data, such as from a patient's bedside and utilize this data for clinical research or provide more personalized care to the patient. As an example, LOCs are an important part of obtaining and analyzing small samples of patient blood or tissue in order to test for certain proteins, bacteria, or viruses. With the present invention, these samples can be obtained and analyzed while a hospitalist or other health care professional goes on rounds at the hospital to check on the condition of one or more patients. Oftentimes, the samples are important temporally since the composition of the substance being tested for is likely to not be present for a very long period, or simply, the health care provider does not have the practical means to capture such data due to the lack of resources currently available.

In one example, type 1 diabetes (T1D) has very complex genetics, with many genes each making relatively small, poorly understood contributions to disease risk. In the case of T1D, the present LOC device can be configured to take patient blood samples, determine a threshold glucose level, and dynamically configure the device to perform further analysis such as on pluripotent stem cell activity, an activity that may or may not require obtaining an additional sample.

As another example, the origin of inflammation is complex and not well understood due to both genetic and environmental factors such as infectious agents, such as with inflammatory bowel disease (IBD), which includes Crohn's disease and ulcerative colitis, which is due to excessive immune response to intestinal microbes. Such immune response could more efficiently be analyzed for purposes of research and clinical diagnosis. The present invention could be configured for a variety of different operations for analyzing inflammation. For example, if a patient exhibited symptoms or had been diagnosed with Crohn's disease, the present invention could receive patient data, obtain sensor measurement data, run software scripts to process and interpret the data and then based on those scripts, another software algorithm would execute in order to reconfigure the microfluidic elements of the device to provide an LOC device for analyzing bone marrow, analysis that may be important in investigating a particular patient's condition or macroscopically for a research inquiry. In one sense, the device can be networked with multiple such devices to create a network of devices for high performance performing a multitude of tests with the high throughput capabilities known in the art. Many other examples exists, some of which are discussed in greater detail in this application.

In another embodiment of the invention, the LOC device addresses the lack of effective solutions in addressing hospital based infections. It is evident from the efforts of the National Institute of Allergy and Infectious Diseases (NIAID), part of the National Institutes of Health (NIH), which has aligned with President Barack Obama's recent National Action Plan for Combating Antibiotio-Resistant Bacteria, that drug-resistant infections are an ongoing issue. With the present invention, health care providers and disease control experts will be able to readily and economically be prepared for detecting antimicrobial resistance.

In another embodiment of the invention, the LOC device addresses the lack of effective solutions in addressing postoperative morbidity and mortality. For example, immunoassays such as the enzyme linked immunosorbent assay (ELISA) and immunofluorocytometry are commonly used for biomarker quantification and could be used to address postoperative care; here, the present invention can be dynamically enabled in a variety of different configurations as an immunoassay LOC device.

In accordance with an embodiment, a dynamic point-of-care LOC device for clinical diagnostic and testing and research applications, the device comprising: a biochemical processing module further comprising, a processor and at least one controller, at least one receiving module for receiving at least one patient sample, at least one microfluidic element including at least one sensor, at least one first software script for receiving and processing at least one data element from the at least one patient sample, an electrically operated interface, a plurality of flow ports, a user interface, memory, a communications link, wherein the receiving module is operatively configured to receive the at least one patient sample, wherein the sensor is configured to detect the at least one data element from at least one sample, wherein the processing module is communicatively linked to the memory, wherein the processing module is communicatively linked to the sensor for processing the at least one data element from the at least one patient sample, wherein the processing module is further operatively configured to execute one or more second software script based on the at least one first software script for receiving and processing the at least one data element from the at least one patient sample, wherein the processing module is operatively linked to the at least one microfluidic element and the electrically operated interface, wherein the plurality of flow ports is linked to the at least one microfluidic element, wherein the processor and controller are communicatively, wherein at least one or more third software script based on the one or more second software script and the at least one software script is communicated between the processor and controller for executing a control signal linked to the user interface for changing at least one aspect of the configuration of the at least one of: the plurality of flow ports and the at least one microfluidic element based on the at least one data element from the at least one patient sample.

In another embodiment, the invention provides for a dynamic LOC device for analyzing blood glucose levels.

In another embodiment, the invention provides for a dynamic LOC device for analyzing stem cell activity.

In another embodiment, the invention provides for a dynamic LOC device for analyzing tumor cell activity.

In another embodiment, the invention provides for a dynamic LOC device for analyzing antimicrobial resistance activity.

In another embodiment, the invention provides for a dynamic LOC device for analyzing activity of one or more pharmacological compounds.

In another embodiment, the invention provides for a dynamic LOC device for analyzing dielectrophoretic separation of cancer cell activity.

In another embodiment, the invention provides for a dynamic LOC device for analyzing germ cell development.

In another embodiment, the invention provides for a dynamic LOC device for analyzing liver cell therapy.

In another embodiment, the invention provides for a dynamic LOC device for analyzing cell-cell signaling.

In another embodiment, the invention provides for a dynamic LOC device for analyzing oral squamous cell carcinoma.

In another embodiment, the invention provides for a dynamic LOC device for analyzing oxidation reduction in human cells.

In another embodiment, the invention provides for a dynamic LOC device for analyzing cardiac biomarkers.

In another embodiment, the invention provides for a dynamic LOC device for analyzing immunological response in human cells.

In another embodiment, the invention provides for a dynamic LOC device for analyzing at least one sample from a human for in vitro experimentation.

In another embodiment, the invention provides for a dynamic LOC device for analyzing at least one sample from a human for in vivo experimentation.

In another embodiment, the invention provides for a dynamic LOC device for analyzing pathogen activity.

In another embodiment, the invention provides for a dynamic LOC device configured to provide an immunoassay.

In another embodiment, the invention provides for a dynamic LOC device comprising configuration capable of magneto-immunosensing.

In another embodiment, the invention provides for a dynamic LOC device comprising configuration capable of a three dimensional (3-D) arrangement.

In another embodiment, the invention provides for a dynamic LOC device configured to provide analysis Micro Total Analysis System (MicroTAS).

These and other embodiments will also become readily apparent to those skilled in the art from the following detailed description of the embodiments having reference to the attached figures, the invention not being limited to any particular embodiment disclosed. These and other embodiments can be adapted as apparatuses, devices, methods, and systems.

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

FIG. 1A illustrates a lab-on-a-chip (LOC) device that is dynamically configured to in accordance with an exemplary embodiment.

FIG. 1B illustrates a lab-an-a-chip device that is dynamically configured 4e in accordance with another exemplary embodiment.

FIG. 2A illustrates an exemplary embodiment of a software application associated with the control of the dynamically configured device from FIG. 1.

FIGS. 2B-2C illustrate additional views of the exemplary embodiment of the software application from FIG. 2A.

FIG. 3 is a block diagram showing an exemplary computing environment in which the technologies described herein can be implemented based on one or more embodiments.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

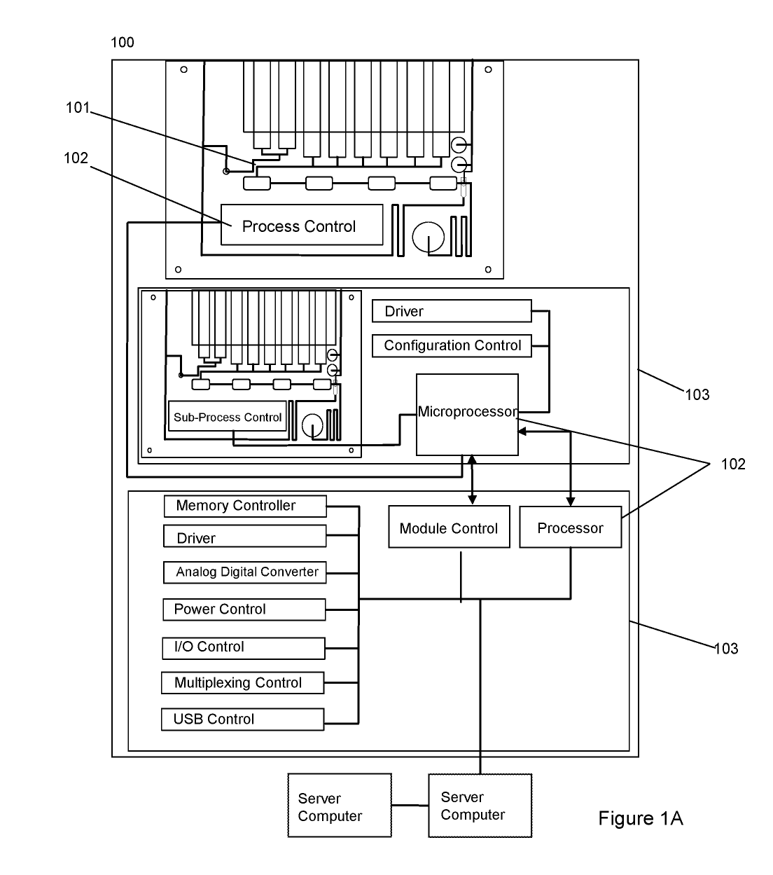

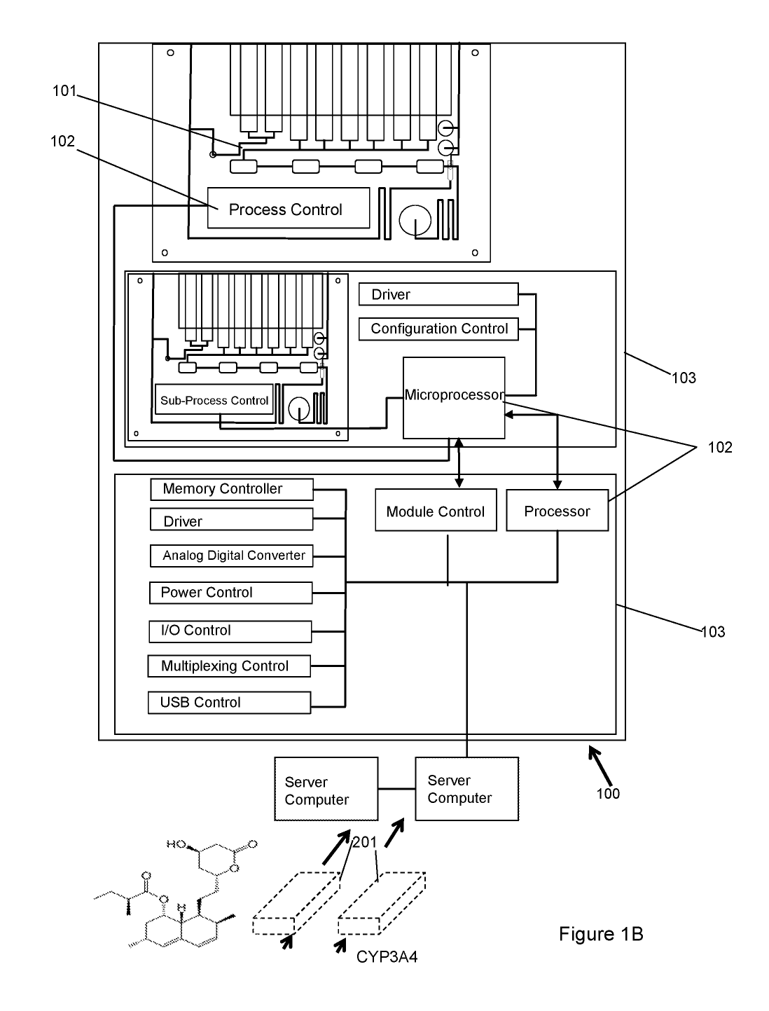

FIG. 1 illustrates a lab-on-a-chip device that is dynamically configured to in accordance with an exemplary embodiment. In FIG. 1, the device illustrated includes microfluidic elements 101. Microfluidic elements 101 typically include one or more microchannels, wells, chambers, microvalves, micropumps, sensors, including biosensors, ports, flow conduits, filters, fluidic interconnections, electrical interconnects, microelectrodes, and related elements.

For the electrically operated interface 103, elements of this interface 103 can include electrically-controlled miniature fluid and gas (gating and routing) valves; small chemical reactors with thermal control; electrical output sensing elements for various physical quantities; interconnecting tubing; electrically-controlled (low DC voltage) fluid and gas transport, control interface electronics; sensor interface electronics; communications and networking electronics, optical waveguide electronics, light emitted diode based electronics and circuitry.

FIG. 1 further comprises a biochemical processing module 102, which further comprises modules for various process control, module control, and processor elements.

Elements of the processing module 102 and electrically operated interface 103 can further include various hardware and software components including bi-directional serial communications (such as the I2C “Inter-Integrated Circuit” protocol; “one-wire” bi-directional serial communications, parallel communication buses and the like. LEDs, communications electronics, electrical outputs and inputs, and addressable parallel latched data ports, DAC, ADC, temperature sensing, and other functions may be used as a principle component of communications electronics as well as simple addressable latch logic chips or discrete circuitry may be used. Other hardware components of the interface 103 includes but are limited to memory controller, driver, multiplexing control, I/O control, USB control, power control, etc. Elements of the processing module 102 can include additional elements to be a fully integrated high throughput LOC device with additional equipment outside the device as optional for various embodiments or combinations thereof.

Processing module 102 can further include biosensors, mixers, blood heaters, SIM card, memory, microprocessor, electrode multiplexers, analog digital converters, power drivers, a SIM card reading mechanism, a timing device, power management circuitry, and the like.

Biosensors can include one or more enzyme-based electrochemical biosensors, calorimetric, potentiometric, acoustic wave, amperometric, optical, piezoelectric, optoelectronic, surface plasmon resonance, fiber optic, bioluminescent, resonant mirror, crystal resonance, thermistor, nanoscale, carbon nanotube, etc.

Active control may include hardware logic, firmware algorithmic logic, software algorithmic logic, external software control via communication ports, analog feedback control systems, digital feedback control systems, combinations thereof, and the like. Active control may be used for process control, configuration management, and system reconfiguration, among others.

Furthermore, a variety of microfluidic design, configuration, and fabrication techniques known in the art, including techniques from chemical, electrical, mechanical, biological, and computer engineering can be applied to make the necessary modifications and combinations for each configuration and embodiment of this invention.

Techniques that can be used in design, configuration, and fabrication include use of magnetic beads, magnets, chemically modified surfaces made of a variety of different materials (i.e., glass, plastic, metal, etc.).

In one or more embodiments for a variety of applications of the device, the processing module is dynamically configured for performing the process associated with the processing module 102 activity based on numerically determined thresholds including mathematically determined thresholds either by way of mathematical or statistical processing either manually or automatically based on a set of software algorithms implemented, once a sample is taken. An example threshold could indicate the presence of a substance in the sample that is beyond a particular range, for which either the dynamic, configuration and resultant processes from the configuration could be performed automatically or manually, moreover, a second dynamic configuration could be manually or automatically be performed based on the results of the first configuration process. A variety of different architectures, networking arrangements, and combinations of processes and thresholds can be utilized. Having this sort of flexibility of design, configuration, implementation, and fabrication allows for advanced levels of research and diagnostics not possible before. Statistical and mathematical analysis mentioned herein may further include graphing, plotting, visual mapping and display, etc.

Further design can allow for dynamic configuration of the device which allows for defined microenvironments by controlling fluidic and surface chemistries, feature sizes, geometries and signal input timing, and thus enable quantitative multi-parameter analysis of single cells, allowing observable dynamic environments approaching in vivo levels of biological complexity. Moreover, efficient parallelization of functional units in microfluidic devices allows high-throughput measurements.

In this and other embodiments the present invention may comprise one or more receiving modules for receiving a sample (i.e., saliva, blood, biological sample, molecule, virus, antigen, protein, other substrates, etc.) from a patient, from a research group, etc.

The device can generally use properties and attributes of a microfluidic system to regulate the movement of the liquids or gases in or operatively linked to the device and generally provides flow control with the goal of carrying out one or more chemical or biochemical processes. Components such as biological or chemical detectors and sensors can be combined with this microfluidic ability to provide the desired analysis.

Various techniques well known in the art of microfluidics, biochemistry, microbiology, and biological and chemical engineering can be implemented in the present invention for dynamic configuration, including aseptic techniques, bacteriological media preparation, isolation of nutritional bacterial mutants, micro scale fermentation, microscopic slide processing, stains and coverslips slides, DNA & Protein Electrophoresis (i.e., agarose gel, SDS-PAGE), column and ion exchange chromatography, protein purification, enzyme and hormone assays, rapid colony transformation, purification and identification of plasmid DNA, blotting, cell culture techniques, PCR, DNA transformation, chromatography (Paper, HPLC, TL ), Direct ELISA, Indirect ELISA, Sandwich ELISA, Western Blot, Flow Cytometry, Electrophoresis, hematological procedures, clinical laboratory test for blood or bodily fluid and secretion, etc.

FIG. 1B illustrates a lab-on-a-chip device that is dynamically configured in accordance with another exemplary embodiment. Removable media elements 201 can be linked, inserted, networked, or coupled via slots or a variety of other means (not depicted in the figure) to be processed by the device, to transport analytes, solvents, antigens, proteins, various molecules, cleaning agents, various fluids, etc.

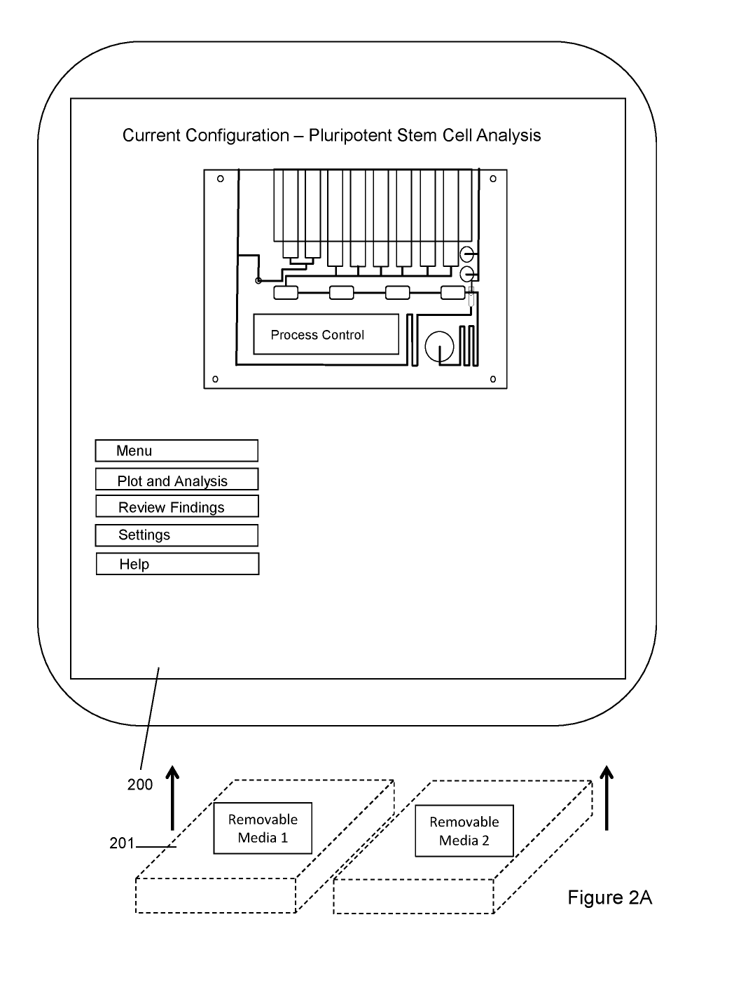

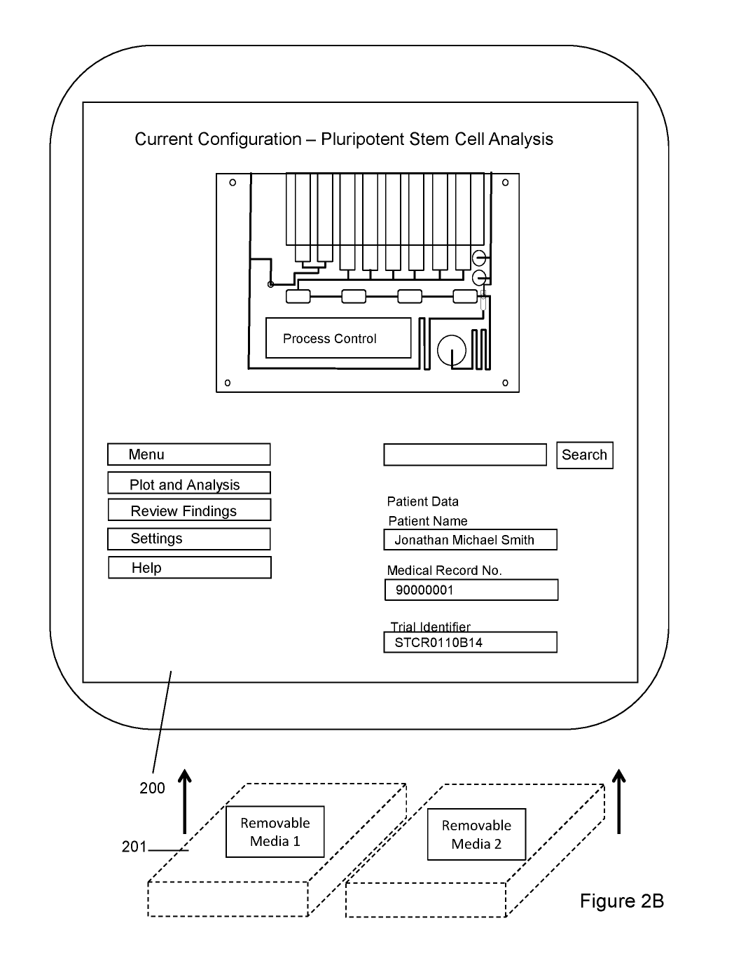

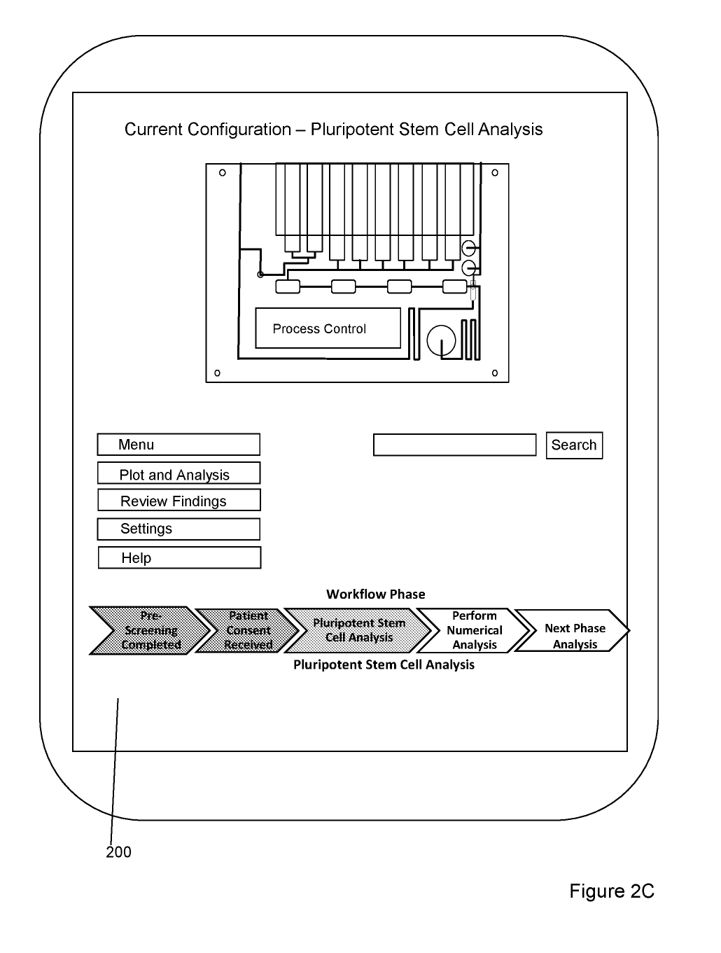

FIG. 2A illustrates an exemplary embodiment of a software application 200 associated with the control of the dynamically configured device from FIG. 1. In FIG. 2, the software comprises a user interface optionally controlled via a transparent touch screen interface for manipulation via one or more portions hands. Gesture and posture recognition and processing well known in the art is preferably employed for an efficient user experience. In one example embodiment, the software application allows the user to visualize the configuration as currently implemented by the system. The user can then move around elements of the system based on either preset functions or configurations, such as for pluripotent stem cell analysis depicted. In moving around elements of the system in the software application, a user, with gesture based commands, for example, touch a certain area of the sensor array of the touch sensitive surface and drag a finger across to a certain area of the screen, can remove the dragged element from the configuration as currently shown. Other combinations of gestures can be used for interpretation as additional control signals for executing an instruction within the application 200.

In yet other embodiments of the software application, the application 200 can be configured to operate with geographic infomation systems and mapping applications.

Removable media elements 201 include any one or more container for storing or transporting fluid for purposes of the operation of the LOC device, either disposable or reusable, detachable or attached, including blood or bodily fluids, antigens, viruses, various substrates, cleaning agents, etc. Additionally, these elements 201 can include one or more injection, syringe, or lancet based elements. Further these elements can also be cartridge based. Further, the removable media elements 201 can be linked, networked, or coupled to the receiving module discussed earlier to ensure accurate adequate delivery of one or more samples.

In an embodiment of invention, application 200 with its Plot and Analysis feature could include mathematical functions, statistical functions, chemical and biological engineering functions, and bioinformatics functions and software tools as a way to perform plotting, calculations, analysis, etc.

FIGS. 2B-2C illustrate additional views of the exemplary embodiment of the software application from FIG. 2A. In FIG. 2B, application 200 comprises a user facing interface with a series of different functions and commands.

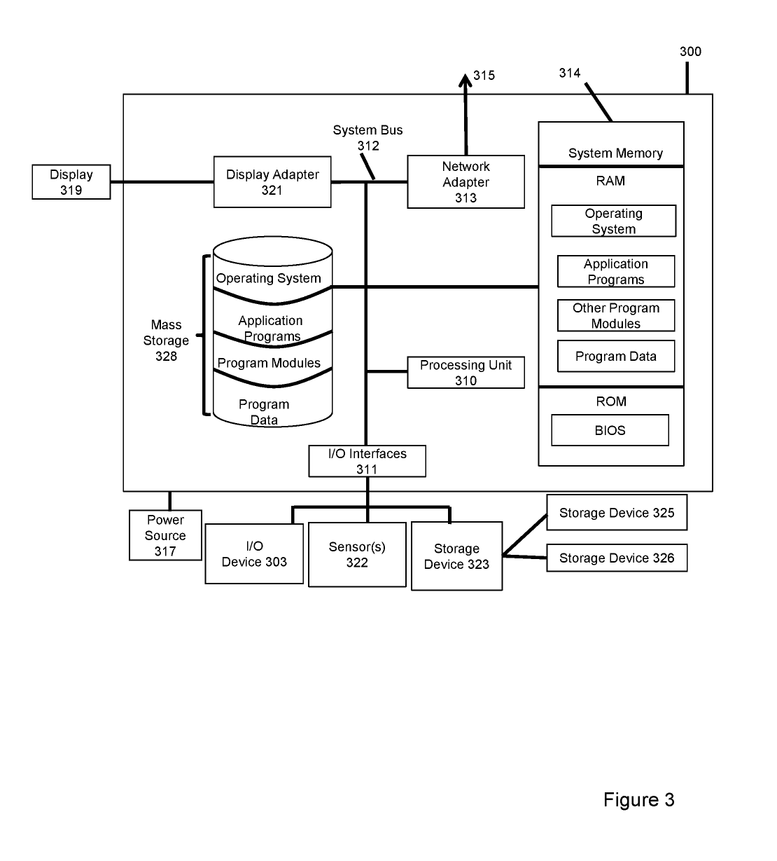

FIG. 3 is a block diagram showing an exemplary computing environment in which the technologies described herein can be implemented based on one or more embodiments. Specifically, such an embodiment depicts software and hardware components in a computing environment. A suitable computing environment can be implemented with systems including but are not limited to, smart devices, microprocessor-based systems, multiprocessor systems, servers, workstations, etc.

Computing environment typically includes a general-purpose computing system in the form of a computing device 300 coupled to various components, such as peripheral devices 323, 325, 326 and the like. Computing device 300 can couple to various other components, such as input devices 306, including voice recognition, touch pads, buttons, keyboards and/or pointing devices, such as a mouse or trackball, via one or more input/output (“I/O”) interfaces 311. The components of computing device 200 can include one or more processors (including central processing units (“CPU”), graphics processing units (“GPU”), microprocessors (“IJP”), and the like) 310, system memory 314, and a system bus 312 that typically couples the various components. Processor 310 typically processes or executes various computer-executable instructions to control the operation of computing device 300 and to communicate with other electronic and/or computing devices, systems or environment (not shown) via various communications connections such as a network connection 315 or the like. System bus 312 represents any number of several types of bus structures, including a memory bus or memory controller, a peripheral bus, a serial bus, an accelerated graphics port, a processor or local bus using any of a variety of bus architectures, and the like.

System memory 314 can include computer readable media in the form of volatile memory, such as random access memory (“RAM”), and/or nonvolatile memory, such as read only memory (“ROM”) or flash memory (“FLASH”). A basic input/output system (“BIOS”) can be stored in non-volatile or the like. System memory 314 typically stores data, computer-executable instructions and/or program modules comprising computer-executable instructions that are immediately accessible to and/or presently operated on by one or more of the processors 310. Mass storage devices 323 and 328 can be coupled to computing device 300 or incorporated into computing device 300 via coupling to the system bus 312. Such mass storage devices 323 and 328 can include non-volatile RAM, a magnetic disk drive which reads from and/or writes to a removable, non-volatile magnetic disk 325, and/or an optical disk drive that reads from and/or writes to a non-volatile optical disk such as a CD ROM, DVD ROM 326. Alternatively, a mass storage device 328, such as hard disk 328, can include non-removable storage medium. Other mass storage devices 328 can include memory cards, memory sticks, tape storage devices, and the like. Mass storage device 328 can be remotely located from the computing device 300.

Any number of computer programs, files, data structures, and the like can be stored in mass storage 328, other storage devices 323, 325, 326 and system memory 314 (typically limited by available space) including, by way of example and not limitation, operating systems, application programs, data files, directory structures, computer-executable instructions, and the like.

Output components or devices, such as display device 319, can be coupled to computing device 300, typically via an interface such as a display adapter 321. Output device 319 can be a liquid crystal display (“LCD”). Other example output devices can include printers, audio outputs, voice outputs, cathode ray tube (“CRT”) displays, tactile devices or other sensory output mechanisms, or the like. Output devices can enable computing device 300 to interact with human operators or other machines, systems, computing environments, or the like. A user can interface with computing environment via any number of different I/O devices 303 such as a touch pad, buttons, keyboard, mouse, joystick, game pad, data port, and the like. These and other I/O devices 303 can be coupled to processor 310 via I/O interfaces 311 which can be coupled to system bus 312, and/or can be coupled by other interfaces and bus structures, such as a parallel port, game port, universal serial bus (“USB”), fire wire, infrared (“IR”) port, and the like.

The computing environment of FIG. 3 can also include sensor(s) 322. Example sensor(s) 322 include, inter alia, include a: GPS, accelerometer, inclinometer, position sensor, barometer, WiFi sensor, radio-frequency identification (RFID) tag reader, gyroscope, pressure sensor, pressure gauge, time pressure gauge, torque sensor, infrared image capture device, ohmmeter, thermometer, microphone, image sensor (e.g. digital cameras), biosensor (e.g. photometric biosensor, electrochemical biosensor), capacitance sensor, radio antenna, augmented reality camera, capacitance probe, proximity card reader, electronic product code reader, any other detection technology, or any combination thereof. It should be noted that the other sensor devices other than those listed can also be utilized to sense context information.

Computing device 300 can operate in a computing environment via communications connections to one or more remote computing devices through one or more cellular networks, wireless networks, local area networks (“LAN”), wide area networks (“WAN”), storage area networks (“SAN”), the Internet, radio links, optical links and the like. Computing device 300 can be coupled to a network via network adapter 313 or the like, or, alternatively, via a modem, digital subscriber line (“DSL”) link, integrated services digital network (“ISDN”) link, Internet link, wireless link, or the like.

Communications connections, such as a network connection 315, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media can include wired media, such as a wired network or direct-wired connection or the like, and wireless media, such as acoustic, radio frequency, infrared, or other wireless communications mechanisms.

Power source 317, such as a battery or a power supply, typically provides power for portions or all of computing environment. In the case of the computing environment being a mobile device or portable device or the like, power source 317 can be a battery. Alternatively, in the case that the computing environment is a smart device or server or the like, power source 317 can be a power supply designed to connect to an alternating current (AC) source, such as via a wall outlet.

Some computers, such as smart devices, may not include several of the components described in connection with FIG. 3. For example, a smart device may not include a user interface. In addition, an electronic badge can be comprised of a coil of wire along with a simple processing unit 310 or the like, the coil configured to act as power source 317 when in proximity to a card reader device or the like. Such a coil can also be configure to act as an antenna coupled to the processing unit 310 or the like, the coil antenna capable of providing a form of communication between the electronic badge and the card reader device. Such communication may not involve networking, but can alternatively be general or special purpose communications via telemetry, point-to-point, RF, infrared, audio, or other means. An electronic card may not include display 319, I/O device 303, or many of the other components described in connection with FIG. 3. Other devices that may not include some of the components described in connection with FIG. 3, include electronic bracelets, electronic tags, implantable devices, computer goggles, other body-wearable computers, smart cards and the like.

Stem Cell Point-Of-Care Device

In one other embodiment, the invention provides for a dynamic LOC device for analyzing stem cell activity. In accordance with an embodiment, the processing module 102 includes one or more sub-elements for processing stem cells including embryonic stem cells, adult stem cells (i.e., somatic stem cells), induced pluripotent stem cells (iPSCs), and the like.

In one example embodiment, based on one or more software algorithms, the configuration of the device and the processing module 102 would be operatively configured to process human pluripotent stem cells to model liver (hepatic) endoderm induction and liver bud formation, based on receiving a sample from the point-of-care user interface of the device. The benefits of such a device have far reaching impacts as not much is known about human endoderm and hepatic endoderm induction from pluripotent stem cells, despite reports demonstrating mature endoderm (pancreas) and hepatic endoderm (hepatocyte) lineages. A variety of configurations including algorithms can be combined and customized to study how key aspects of the physiological, biochemical, and biophysical environment influence signaling factors and transcription factors.

Tumor Cell Activity Point-of-Care Device

In another embodiment, the invention provides for a dynamic LOC device for analyzing tumor cell activity. In accordance with an embodiment, the processing module 102 includes one or more sub elements for processing and analyzing tumor cells including but not limited to tumor cells related to carcinoma, including adenocarcinoma, basal cell carcinoma, squamous cell carcinoma, and transitional cell carcinoma; sarcoma; leukemia; lymphoma and myeloma; central nervous system cancers, breast cancer, lung cancer, etc. Further techniques known in the art of design, configuration, and fabrication of microfluidics devices can be implemented to provide capabilities of process necessary for exploring aspects of cancer genetics including for oncogenes, tumor suppressor genes, DNA repair, RNA biology, signal transduction pathways, nuclear hormone receptors, transcriptional factors, cancer cell metabolism, structural biology and the tumor microenvironment. In other embodiments, the processing module is dynamically configured for analyzing tumor cell activity from at least one clinical sample based on numerical values determined one or more thresholds including mathematically determined thresholds either by way of mathematical or statistical processing either manually or automatically based on a set of software algorithms.

Pharmacological Compound Activity Paint-of-Care Device

In another embodiment, the invention provides for a dynamic LOC device for analyzing activity of one or more pharmacological compounds. In accordance with an embodiment, the processing module 102 includes one or more sub elements for processing and analyzing activity of one or more pharmacological compounds using one or more high-throughput methods for analyzing pharmacological compound interaction including among one or more compounds, drug discovery/delivery, cell-drug interactions, and the like. Further techniques known in the art of design, configuration, and fabrication of microfluidics devices including knowledge in the art on material selection, surface modification, cell trapping/pattering, concentration gradient generation and mimicking of in vivo environment to achieve the designed dynamically configurable embodiment. In other embodiments, the processing module is dynamically configured for analyzing activity of one or more pharmacological compounds based on numerical values determined one or more thresholds including mathematically determined thresholds either by way of mathematical or statistical processing either manually or automatically based on a set of software algorithms.

Electrosynthesis of Drug Metabolites Point of Care Device

In yet another embodiment, the invention provides for a dynamic LOC device for analyzing activity of one or more drug metabolites. As only one example application of many, it is well known that Cytochrome P450 (CYP) has in important role in human biology, CYP is used by the body to metabolize and transform a range of hydrophobic xenobiotics and also used in the synthesis of important signaling molecules, such as steroid hormones in the endocrine glands and fat-soluble vitamins. The present LOC device can be dynamically configured to perform various processes for testing and research. For example, for CYP, in response to a patient having a medical condition or adverse effects to a drug therapy, the chemical outcome of the first pass hepatic oxidation is key information to any drug development process. Electrochemistry can be used to simulate CYP450 oxidation, yet it is often confined to the analytical scale, hampering product isolation and fill characterization.

In an example, if the patient was in need of HMG CoA Reductase Inhibitors, the invention, as a point of care device could receive and analyze a sample from the patient's body to study the effects of interactions between CYP450 (incl. CYP3A4) and lovastatin, simvastatin, atorvastatin, fluvastatin, etc.

Lovastatin:

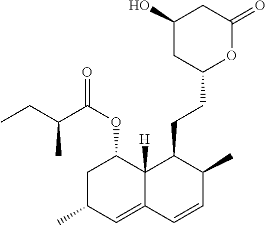 [SMILES: CC[C@H](C)C(=O)O[C@H]1C[C@@H](C)C=C2C=C[C@H](C)[C@H](CC[C@@H]3C[C@@H](O)CC(=O)O3)[C@H]21]

Simvastatin:

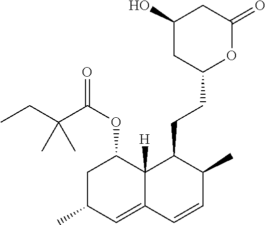 [SMILES: CCC(C)(C)C(=O)O[C@H]1C[C@@H](C)C=C2C=C[C@H](C)[C@H](CC[C@@H]3C[C@@H](O)CC(=O)O3)[C@H]21]

Statin molecules each provide unique attributes based on their different ring structures and side chains as can be seen in the depictions above, including affinity to the active site of the target enzyme, HMGCR, rates of entry into liver versus non-liver cells, systemic availability of the compounds in the body, and biochemical metabolism and excretion pathways that affect the biologic half-life of the active compound. Each of these unique attributes and features can be parameterized and numerically analyzed in at least one embodiment of the LOC device based upon receiving a sample and analyzing it.

In another example of this embodiment, the present invention can be adapted to enhance drug production and supply by serving as a tool using one or more software features to manage just-in-time pharmaceutical production and supply chains.

Cancer Cell Activity Point-of-Care Device

In another embodiment, the invention provides for a dynamic LOC device for analyzing dielectrophoretic separation of cancer cell activity, through implementation of techniques known in the art of design, configuration, and fabrication of microfluidics devices including dielectrophoresis (DEP), insulator-Based Dielectrophoresis (iDEP), Irreversible Electroporation (IRE), etc. In other embodiments, the processing module is dynamically configured for analyzing dielectrophoretic separation of cancer cell activity based on numerical values determined one or more thresholds including mathematically determined thresholds either by way of mathematical or statistical processing either manually or automatically based on a set of software algorithms.

Germ Cell Development Point-of-Care Device

In another embodiment, the invention provides for a dynamic LOC device for analyzing germ cell development. In other embodiments, the processing module is dynamically configured for analyzing germ cell development based on numerical values determined one or more thresholds including mathematically determined thresholds either by way of mathematical or statistical processing either manually or automatically based on a set of software algorithms.

Cell-Cell Signaling Point-of-Care Device

In another embodiment, the invention provides for a dynamic LOC device for analyzing cell-cell signaling. In other embodiments, the processing module is dynamically configured for analyzing cell-cell signaling based on numerical values determined one or more thresholds including mathematically determined thresholds either by way of mathematical or statistical processing either manually or automatically based on a set of software algorithms.

Oral Squamous Cell Carcinoma Point-of-Care Device

In another embodiment, the invention provides for a dynamic LOC device for analyzing oral squamous cell carcinoma. In an example of this embodiment, bodily fluid such as saliva would be received via a collection element (i.e., an injection pump or chamber, disposable mouthpiece, etc.), antibodies via magnetic beads would assist in removal of lymphocytic cells, wherein the cells would further be enriched with magnetic beads functionalized with antibodies to the specific dysplastic and cancer expressed cell surface proteins, allowing for the oral cancer cells to be isolated and detected. In other embodiments, the processing module is dynamically configured for analyzing oral squamous cell carcinoma based on numerical values determined one or more thresholds including mathematically determined thresholds either by way of mathematical or statistical processing either manually or automatically based on a set of software algorithms.

Immunological Response Analysis Point-of-Care Device

In yet another embodiment, the invention provides for a dynamic LOC device for analyzing immunological response in human cells. The device can be designed and dynamically configured for analysis of exaggerated immune responses in relation to allergies, autoimmunity and cancer, information processing pathways, cell-to-cell variability, stochastic molecular interactions, dynamic molecular and cellular interactions, time-dependent analysis, etc. Other design and fabrication techniques known in the art can be applied to the device allowing for study of cell-cell signaling, migration, differentiation, antibody and cytokine production, clonal selection, and cell lysis, thereby enabling advanced level research and analysis of immunological response in vitro.

In other embodiments, the processing module is dynamically configured for analyzing immunological response based on numerical values determined one or more thresholds including mathematically determined thresholds either by way of mathematical or statistical processing either manually or automatically based on a set of software algorithms.

Pathogen Analysis Point-of-Care Device

In yet another embodiment, the invention provides for a dynamic LOC device for analyzing activity of at least one pathogen. In this and other embodiments, with a variety of capabilities and features discussed above, the device can be designed and fabrication to provide dynamic configuration for the detection of many microorganisms from biological samples including HIV, malaria, tuberculosis, diarrheal diseases, pertussis, dengue fever, enteric bacterial pathogens such as one or more forms of Campylobacter jejuni, Escherichia coli, Shigella dysenteriae, Salmonella, various other pathogens, etc. In other embodiments, the processing module is dynamically configured for analyzing activity of at least one pathogen based on numerical values determined one or more thresholds including mathematically determined thresholds either by way of mathematical or statistical processing either manually or automatically based on a set of software algorithms.

Immunoassays for Point-of-Care Device

In another embodiment, the invention provides for a dynamic LOC device comprising configured to provide an immunoassay, such as one or more immunoassays for Alzheimer's Disease or other neurodegenerative diseases. In other embodiments, the processing module is dynamically configured to provide an immunoassay based on numerical values determined one or more thresholds including mathematically determined thresholds either by way of mathematical or statistical processing either manually or automatically based on a set of software algorithms.

In yet another embodiment, the invention provides for a dynamic LOC device comprising configuration capable of a three-dimensional (3-D) arrangement.

Glucose Monitoring Point-of-Care Device

Glucose monitoring devices are ubiquitous with the care and management of diabetes, both clinical and non-clinical settings. Blood glucose monitoring devices such as those manufactured and marketed by OneTouch® are well known in the industry.

Glucose meters, or measurement devices, generally have a lancing, or lanceting device such as a metal needle for obtaining a blood sample from a user as well as a disposable electrochemical test strip for testing the sample for glucose levels. More recent innovations also include laser based lancing device along with a strip.

Generally, most devices measure glucose in a blood sample by reaction of the sample with glucose oxidase to form gluconic acid, which then reacts with ferricyanide to form ferrocyanide. The electrode oxidizes the ferrocyanide, and this generates a current directly proportional to the glucose concentration which is then displayed as a numerical output.

While it is well know how to monitor and test for glucose levels in the blood, there is little or no way for this to translate into clinical and lab research without significant resources. For example, researchers at Harvard have recently discovered a method of producing not only beta cells from stem cells, but also alpha cells (which produce glucagon) and delta cells and there is potential for the researchers to be able to create fully customizable islets (See Harvard Stem Cell Institute. “From stem cells to billions of human insulin-producing cells.” Oct. 9, 2014, http://hsci.harvad.edu/new/stem-cells-billions-human-insulin-producing-cells.

In another embodiment of this invention, a dynamic point-of-care LOC device for analyzing blood glucose, the device comprising: a testing strip module, a lanceting module, a biochemical processing module further comprising, a processor and at least one controller, at least one receiving module for receiving at least one patient sample, at least one microfluidic element including at least one sensor, at least one first software script for receiving and processing at least one data element from the at least one patient sample, an electrically operated interface, a plurality of flow ports, a user interface, memory, a communications link, wherein the receiving module is operatively configured to receive the at least one patient sample, wherein the sensor is configured to detect the at least one data element from at least one sample, wherein both the receiving module and sensor are linked to the lanceting module and testing strip module, wherein the lanceting module and testing strip module are communicatively linked to the processing module, wherein the processing module is communicatively linked to the memory, wherein the processing module is communicatively linked to the sensor for processing the at least one data element from the at least one patient sample, wherein the processing module is further operatively configured to execute one or more second software script based on the at least one first software script for receiving and processing the at least one data element from the at least one patient sample, wherein the processing module is operatively linked to the at least one microfluidic element and the electrically operated interface, wherein the plurality of flow ports is linked to the at least one microfluidic element, wherein the processor and controller are communicatively, wherein at least one or more third software script based on the one or more second software script and the at least one software script is communicated between the processor and controller for executing a control signal linked to the user interface for changing at least one aspect of the configuration of the at least one of: the plurality of flow ports and the at least one microfluidic element based on the at least one data element from the at least one patient sample.

Such a system allows for a health care provider to send data for clinical research immediately rather than having to use a multitude of processes for providing such data, thereby helping to reduce costs of vital research while enabling cutting edge clinical patient care.

Multiple Mode Configuration for Point of Care Clinical Diagnostics and Research

In another embodiment of this invention, the device can be dynamically configured to perform one or more of the above functions and features simultaneously or in a timed sequence. For example, the system could be setup such that when a Compound X is completely mixed with Compound Y, either based on a subprocess test or based on timing, a second process for analyzing or processing the same or another set of compounds could occur, alternatively, such second process could also be carried out in parallel with the mixing or other process associated with Compound X and Compound Y.

A notable advantage of the system is that with the processing hardware and software algorithms that can be used with the invention, it is possible to perform certain steps in the system based on numerical calculations either done by the invention or else, data received and interpreted by the system from an external database.

Mobile Device Applications for Remote Regions

The present invention, in an embodiment, can be designed and fabricated such that point of care data can trigger software scripts to dynamically configure the invention in conjunction with a mobile device such as a smartphone, etc. For example, the device can either be fully integrated with the mobile device and use many of the communication and interface features associated with a mobile device, or alternatively, the invention can be adapted as a peripheral device that can be operatively linked to a mobile device or a network of such devices. Such a feature can provide for important clinical diagnostic and research resources in remote and/or underserved regions, or even in a busy hospital where a health care provider relies on a mobile device for communication. For example, disease epidemics such as Ebola, malaria, and the like, often hit regions where resources are limited. By providing the present invention, research into epidemics is facilitated on the spot, providing a new level of short and long term care to patients in need, as well as providing a way to more effectively manage distribution and manufacturing supply chains for necessary pharmaceuticals.

In both mobile and non-mobile context of the invention, the device could be configured to incorporate functionality and features of one or more various types of sensors including acoustic, sound, thermal, environmental, optical, mechanical, acceleration, proximity, motion, electric, magnetic, automotive, pressure, velocity, temperature, heat, presence, position, angle, displacement, distance, current, potential, radio, light, imaging, photon, fluid velocity, vibration, gyro, and the like.

Multiple-Criteria Decision-Making (MCDM) or Multiple-Criteria Decision Analysis (MCDA) Point of Care Analysis

In another embodiment of this invention, the device can be dynamically configured to perform one or more of the above functions and features with one or more Multiple-criteria decision-making (MCDM) or multiple-criteria decision analysis (MCDA) applications and tools. With such an embodiment, hospitals and health care professionals can have far more powerful decision making tools for optimizing patient care and minimizing costs. For example, in an example, based on the analysis provided by the device patients receiving diazepam or other types of benzodiazepines, a hospital could set up the device and its associated software to produce suggestions and option choices when certain parameters and thresholds are met, within range of, or are exceeded, in order to reduce deaths or adverse health effects related to drug interactions. In yet another example, the device could be instrumental during times of widespread hospital infections or epidemics in helping to maintain policies and protocols, such that decision makers at every level can adhere to those parameters. As such, the device would be instrumental in setting new parameters and standards related to what to do when specific incidents occur, as opposed to only using the device to implement a policy already being followed prior to utilization of the device.

In yet other embodiments, the device can be configured to provide patient statistics and categorizations based an numerical values, such as “high risk” or “low risk” for a particular condition. Such embodiments can incorporate a vast amount of customization and scalability particular to a health care organization's needs and policies and procedures.

Optical Microscopy, Flow Cytometry, and Microscopy Based Device

In another embodiment, the invention provides for a dynamically configurable LOC device for providing flow cytometry analysis.

In another embodiment, the invention provides for a dynamically configurable LOC device for providing optical microscopy analysis.

In another embodiment, the invention provides for a dynamically configurable LOC device for providing lens free microscopy analysis.

In another embodiment, the invention provides for a dynamically configurable LOC device for providing lens microscopy analysis.

In another embodiment, the invention provides for a dynamically configurable LOC device for providing tomography analysis.

Molecular Electronics Based Point of Care System

In another embodiment, the invention provides for a dynamically configurable LOC device with at least one configuration based on one or more molecular electronic components, either through self-assembly or induced. Various aspects of molecular electronics known in the art or discussed can be utilized as the active (switching, sensing, etc.) or passive (current rectifiers, surface passivants) elements, as well as various fabrication methods, materials, etc.

Wearable Devices

In another embodiment, the invention provides for a dynamically configurable LOC device that can combine any of the above features and examples mentioned to be adapted for wear or use as a wearable device. As an example, as a wearable device, the invention can receive physiological data from a human user or a sample from the user wearing the said device, which can be analyzed by the system and with which further processing could be done. Combining the aspects and features of a wearable device allows for the device to be created in such a way as to provide more personalized care to individual patients.

Database, Data Analysis, and Security

The present LOC device is communicatively linked to at least one database for data storage and retrieval. Data element can include any data received or transmitted to and from the device, including but not limited to patient data, patient sample data, scientific data, medical data, health information data, chemical or biological data, and the like. In one embodiment, the device can be interfaced with a software application with varying levels of administration and security in order to perform administration from a researcher's role, a governmental role, a health care administrator's role, a physician's role, a patient's role, and the like. In order to optimize the security aspects of data management, ownership, and transmission, the system can provide for software architecture, design, and implementation that adhere to rules and regulations and standards of data security instituted by hospitals, professional organizations, and private and public sector organizations and federal, state, and national privacy and health care laws, including the Health Insurance Portability and Accountability Act (HIPAA). This includes encryption of private health information using secure TCP/IP network encryption technology, such as Secure Socket Layer (SSL) encryption (128 bit, etc.).

Further, for data security and privacy, a key generation module can generate a public key and private key according to an asymmetric key algorithm, such as the RSA algorithm, the EIGamal algorithm, and the Pailier algorithm and the like. Data may be collected from a patient using a modality such as a CT scan device, or by a medical professional involved in the care and/or health records of the patient. The private health information may be stored and transferred according to the Digital Imaging and Communications in Medicine (DICOM) standard, published by the American College of Radiology and the National Electronic Manufacturers Association. Medical images, which may also constitute private health information, may be stored and retrieved using a Picture Archiving and Communication System (PACS). The key generation module can further generate a symmetric key according to a symmetric key algorithm such as Blowfish, Twofish, or Serpent and the like. The system can be implemented using a variety of encryption and decryption methods known in the art.

Health Information Systems, Lab Information Systems, and Telemetry

The present invention can further be adapted to communicate via a network(s) with a health information system (IIIS) and/or a lab information system and can further be configured to integrate or link with electronic medical records and related systems.

The present invention can further be adapted to communicate with one or more telemetry systems and networks.

Video Gesture Recognition, Virtual Reality, Artificial Intelligence, Robotics, Camera

The present device can further be configured to operate with a module for video gesture recognition, virtual reality, artificial intelligence, robotics, imaging, audio signaling processing, and the like.

Drone Technology for Point-of-Care Health Care Delivery

In another embodiment, the present invention comprises a device configurable for aerial delivery of items to a destination location, including configurability and/or communicative and/or physical linkage to one or more unmanned aerial vehicles configured to aerially transport items; an unmanned aerial vehicle management system further including a processor, and a memory communicatively linked to the processor, a software script communicatively linked to the processor for executing instructions for various processes including processing a request to deliver an item to a destination location, sending to an unmanned aerial vehicle one or more unmanned aerial vehicles, delivery parameters identifying an origin location that includes the item and a destination location; wherein one or more unmanned aerial vehicles, in response to receiving the delivery parameters, is capable of navigating to the source location, coupling or securing within the vehicle the item located at the origin location and then navigating to one or more destination locations; removing the item for delivery.

In such embodiments, the opportunities for point-of-care health care are vast, including providing point-of-care diagnostics and analysis in remote places, in crisis situation, etc.

Such a drone based device can even be programmed for delivery to specific coordinates within a hospital network or within a building or directly to an emergency room or pathology, or where the appropriate further configurations are necessary. For example, in another example, if in a drone delivery embodiment the device were to navigate to a remote location, then collect the necessary sample, and navigate to a nearby hospital, the device would have such capabilities that it could reconfigure while en route to the location or right upon delivery of the sample, where, a human user could link or without human intervention, the device could link to one or more medical devices such as microscopes, medical imaging apparatuses, etc. Drug delivery in remote regions could also be transform by such a drone enabled LOC point-of-care device. Moreover, the device could be configured to enable safe navigation and delivery based on the movement and physics of drone flight.

Multiple devices of the invention can be deployed and networked for more robust drone delivery.

Dynamic configuration of the invention can be optimized for more robust drone delivery specific requirements.

### REFERENCES

Armache, K. J., Mitterweger, S., Meinhart, A., and Cramer, P. (2005) Structures of Complete RNA Polymerase II and Its Subcomplex, Rpb4/7. J Bid Chem 280, 7131-7134. PMID: 15591044.
Castle, P. E, Shaber, R, Lamere, B., Kinney, W., Fettermnnan, B., Poitras, N., Lorey, T., Schiffman, M., Dunne, A., Ostolaza, J., McKinney, S. and Burk, R. Human papillomavirus (HPV) genotypes in men with cervical precancer and cancer at Kaiser Permanente Northern California. Cancer Epidemid. Biomarkers Prev. 20:946-953, 2011. PMID: 21415357; PMCID: PMC3117227.
Cho C. H., Parashurama N., Park h. Y. H., Suganuma K., Nahniias Y., Park J., Tilles A. W., Berthiaume, F., Yarmush, M. L. “Homogeneous differentiation of hepatocyte-like cells from embryonic stem cells applications for the treatment of liver failure”, Faseb J. 22, 898-909 (2008).
Christodoulides N, Pierre F N, Sanchez X, et al. Programmable Bio-Nano-Chip Technology for the Diagnosis of Cardiovascular Disease at the Point-of-Care. Methodist DeBakey Cardiovascular Journal. 2012; 8(1):6-12.
Gascoyne P R C, Wang X-B, Huang Y, Becker F F. Dielectrophoretic Separation of Cancer Cells from Blood. IEEE transactions on industry applications. 1997; 33(3):670-678. doi: 10.1109/28.585856.
Drug Interactions, Cytochrome P450 Drug Interaction Table. http://medicine.iupui.edu/elinpharm/ddis/main-table. Indiana University Department of Medicine. last accessed Jan. 2, 2016.
Foudeh A. M., Fatanat Didar T., Veres T., Tabrizian M. Microfluidic designs and techniques using lab-on-a-chip devices for pathogen detection for point-of-care diagnostics. Lab Chip. 2012 Sep. 21; 12(18):3249-66. doi: 10.1039/c21c40630f. Epub 2012 Aug. 2.
Galletti Giuseppe, Sung Matthew S., Vabdat Linda T., Shah Manish A. Santana Steven M., Altavilla Giuseppe, Kirbyd Brian J., and Giannakakou Paraskevi. Isolation of breast cancer and gastric cancer circulating tumor cells by use of an anti HER2-based microfluidic device Lab Chip, 2014, 14, 147. The Royal Society of Chemistry.
Heath James R, Annual Review of Materials Research, Vol. 39: 1-23 (Volume publication date August 2009).
Hendriks W T, Warren C R, Cowan C A. Genome Editing in Human Pluripotent Stem Cells: Approaches, Pitfalls, and Solutions. Cell Stem Cell. 2016 Jan. 7; 18(1):53-65. di: 10.1016/j.stem.2015.12.002. Review.
Hergott, Christopher B; Roche, Aoife M; Naidu, Nikhil A; Mesaros, Clementina; Blair, Ian A; Weiser, Jeffrey N. Bacterial exploitation of phosphorylcholine mimicry suppresses inflammation to promote airway infection. 2015-10-23; 1558-8238, Journal of clinical investigation—id: 1807972.
Jani Ilesh V., M.D., Ph.D., and Peter Trevor F., Ph.D., M.P.H. How Point-of-Care Testing Could Drive Innovation in Global Health. N Engl J Med 2013; 368:2319-2324 Jun. 13, 2013. DOI: 10.1056/NEJMsb1214197.
Kim, Y. and Langer, R. 2015. Microfluidics in Nanomedicine. Reviews in Cell Biology and Molecular Medicine. 1:127-152.
Lee Do-Hyun, Bae Chae Yun, Kwana Seyong and Park, Je-Kyun. User-friendly 3D bioassays with cell-containing hydrogel modules: narrowing the gap between microfluidic bioassays and clinical end-users' needs. Lab Chip, 2015, 15, 2379. The Royal Society of Chemnistry.
Mank M G, Ziober B L, Chen Z, Thompson J A, Dau IIII. Lab-on-a-clip technologies for oral-based cancer screening and diagnostics: Capabilities, issues, and prospects. Ann N Y Acad Sci 2007; 1098:467.475.
Medina-Sinchez M, Miserere S, Morales-Narváez E, Merkoçi A. On-chip magneto-immunoassay for Alzheimer's biomarker electrochemical detection by using quantum dots as labels. Biosens Bioelectron. 2014 Apr. 15; 54:279-84. doi: 10.1016/j.bios.2013.10.069. Epub 2013 Nov. 7.
ODonnell R K, Kupferman M, Wei S J, Singhal S, Weber R, (OMalley B, Cheng Y, Putt M, Feldman M, Ziober B, Muschel R J.: Gene expression signature predicts lymphatic metastasis in squamnus cell carcinoma of the oral cavity. Oncogene 24(7): 1244-51, February 2005.
Pertti J. Neuvonon, Janne T. Backman, Mikko Niemi. Pharmacokinetic Comparison of the Potential Over-the-Counter Statins Simvastatin, Lovastatin, Fluvastatin and Pravastatin. Clinical Pharmacodinetics July 2008, Volume 47, Issue 7, pp 463-474 First online: 13 Sep. 2012.
Sasso L A, Aran K, Guan Y, Ündar A, Zahn J D. CONTINUOUS MONITORING OF INFLAMMATION BIOMARKERS DURING SIMULATED CARDIOPULMONARY BYPASS USING A MICROFLUIDIC IMMUNOASSAY DEVICE—A PILOT STUDY. Artificial organs. 2013; 37(1):E9-E17. DOI: 10.1111/aor.12021.
Stalder Romain, and Roth Gregory P. Preparative Microfluidic Electrosynthesis of Drug Metabolites. Sanford-Burnham Medical Research Institute. ACS Med. Chem. Lett., 2013, 4 (11), pp 1119-1123. DOI: 10.1021/ml400316p. Publication Date (Web): Oct. 1, 2013.
Yoon J-Y, Kim B. Lab-on-a-Chip Pathogen Sensors for Food Safety. Sensors (Basel, Switzerland). 2012; 12(8):10713-10741. DOI:10.3390/s120810713.

What is claimed is:

1. In accordance with an embodiment, a dynamic point-of-care LOC device for clinical diagnostic and testing and research applications, the device comprising:
a biochemical processing module further comprising:
a processor and at least one controller,
at least one receiving module for receiving at least one patient sample,
at least one microfluidic element including at least one sensor,
at least one first software script for receiving and processing at least one data element from the at least one patient sample,
an electrically operated interface,
a plurality of flow ports,
a user interface,
memory,
a communications link,
wherein the receiving module is operatively configured to receive the at least one patient sample,
wherein the sensor is configured to detect the at least one data element from at least one sample,
wherein the processing module is communicatively linked to the memory,
wherein the processing module is communicatively linked to the sensor for processing the at least one data element from the at least one patient sample,
wherein the processing module is further operatively configured to execute one or more second software script based on the at least one first software script for receiving and processing the at least one data element from the at least one patient sample,
wherein the processing module is operatively linked to the at least one microfluidic element and the electrically operated interface,
wherein the plurality of flow ports is linked to the at least one microfluidic element,
wherein the processor and controller are communicatively,
wherein at least one or more third software script based on the one or more second software script and the at least one software script is communicated between the processor and controller for executing a control signal linked to the user interface for changing at least one aspect of the configuration of the at least one of: the plurality of flow ports and the at least one microfluidic element based on the at least one data element from the at least one patient sample.

2. The device of claim 1 wherein the sensor comprises one or more of: enzyme-based electrochemical biosensors, calorimetric, potentiometric, acoustic wave, amperometric, optical, piezoelectric, optoelectronic, surface plasmon resonance, fiber optic, bioluminescent, resonant mirror, crystal resonance, thermistor, nanoscale, carbon nanotube, acoustic, sound, thermal, environmental, optical, mechanical, acceleration, proximity, motion, electric, magnetic, automotive, pressure, velocity, temperature, heat, presence, position, angle, displacement, distance, current, potential, radio, light, imaging, photon, fluid velocity, gyro, and vibration sensors.

3. The device of claim 1 wherein the one or more third software script comprises at least one script for dynamic configuration for enabling one or more of: analyzing blood glucose levels, analyzing stem cell activity, analyzing tumor cell activity analyzing antimicrobial resistance activity, analyzing activity of one or more pharmacological compounds, analyzing dielectrophoretic separation of cancer cell activity, analyzing germ cell development, analyzing liver cell therapy, analyzing cell-cell signaling, analyzing oral squamous cell carcinoma, analyzing oxidation reduction in human cells, analyzing immunological response in human cells, for analyzing pathogen activity, for providing an immunoassay, for providing a platform for magneto-immunosensing.

4. The device of claim 1 wherein the one or more third software script comprises at least one script for dynamic configuration for enabling analyzing activity of one or more drug metabolites.

5. The device of claim 1 wherein the processor is communicatively linked to a software application.

6. The software application of claim 4, wherein the software is configured to perform a numerical operation.

7. The software application of claim 4, wherein the software is configured to perform a numerical operation.

8. The software application of claim 4, wherein the software is configured to perform Multiple-Criteria Decision Analysis.

9. The software application of claim 4, wherein the software is configured to communicate with one or more of: a health information system and a lab information system.

10. The software application of claim 4, wherein the software is configured to perform data analysis.

11. The software application of claim 4, wherein the software is configured communicate with at least one external database.

12. The device of claim 1 wherein the one or more third software script comprises at least one script for dynamic configuration for enabling a three-dimensional arrangement of the device.

13. The device of claim 1 wherein the one or more third software script comprises at least one script for dynamic configuration for providing a drone delivery based point-of-care system.

14. The device of claim 1 wherein the processor is communicatively linked to a mobile device.

15. The device of claim 1 wherein the processor is communicatively linked to a network.

16. The device of claim 1 wherein the processor is designed to be worn as a wearable device.

17. The device of claim 1 wherein the processor is communicatively linked to a medical imaging apparatus.

18. The device of claim 1 wherein the at least one microfluidic element includes at least one molecular electronic element.

19. The device of claim 1 wherein the one or more third software script comprises at least one script for dynamic configuration for providing one or more of: flow cytometry analysis, optical microscopy analysis, lens free microscopy analysis, lens microscopy analysis, and tomography analysis.

20. The device of claim 1 wherein the one or more third software script comprises at least one script for dynamic configuration for enabling one or more of: DNA electrophoresis, protein electrophoresis, column chromatography, ion exchange chromatography, protein purification, enzyme assay, hormone assay, rapid colony transformation, purification and identification of plasmid DNA, blotting, cell culture, PCR, DNA transformation, chromatography, ELISA, hematological procedures, and clinical laboratory testing.
